(19) United States
(12) Patent Application Publication
(10) Pub. No.: US 2024/0256745 A1
(43) Pub. Date: Aug. 1, 2024

(54) METHOD AND SYSTEM FOR ANALYZING TRANSIENT CURRENT OF NON-POLAR LIQUID, APPARATUS, AND STORAGE MEDIUM

(71) Applicants: SOUTH CHINA NORMAL UNIVERSITY, Guangzhou, Guangdong (CN); SHENZHEN GUOHUA OPTOELECTRONICS CO., LTD., Longhua, Shenzhen, Guangdong (CN)

(72) Inventors: Dong YUAN, Panyu District, Guangzhou, Guangdong (CN); Wei LIU, Panyu District, Guangzhou, Guangdong (CN); Alexander Victor HENZEN, Panyu District, Guangzhou, Guangdong (CN); Jan GROENEWOLD, Panyu District, Guangzhou, Guangdong (CN); Mohammad Khorsand AHMADI, Groene Loper (NL); Hans Markus WYSS, Groene Loper (NL); Jacob Marinus Jan DEN TOONDER, Groene Loper (NL); Guofu ZHOU, Panyu District, Guangzhou, Guangdong (CN)

(73) Assignees: SOUTH CHINA NORMAL UNIVERSITY, Guangzhou, Guangdong (CN); SHENZHEN GUOHUA OPTOELECTRONICS CO., LTD., Longhua, Shenzhen, Guangdong (CN)

(21) Appl. No.: 18/564,244

(22) PCT Filed: Aug. 11, 2021
(86) PCT No.: PCT/CN2021/111975

§ 371 Date: Feb. 2, 2024

(30) Foreign Application Priority Data
May 28, 2021 (CN) 202110592281.4

(51) Int. Cl. G06F 30/28

(52) U.S. Cl. CPC G06F 30/28

(57) ABSTRACT

A method and a system for analyzing a transient current of a non-polar liquid, and an apparatus are disclosed. The method includes: measuring a transient current of a to-be-detected device to obtain a transient current reference curve; determining experimental parameters of a first influencing factor in the to-be-detected device according to the transient current reference curve and preset equations, and measuring experimental parameters of a second influencing factor in the device; constructing a transient current reference model according to the experimental parameters of the first and second influencing factors and a preset current model; adjusting parameters of the first and/or second influencing factor in the transient current reference model to obtain a plurality of transient current models; and calculating corresponding transient current change data according to the transient current models to construct and output a plurality of transient current curves.

### CROSS-REFERENCE TO RELATED APPLICATIONS

This application is a national stage filing under 35 U.S.C. § 371 of international application number PCT/CN2021/111975, filed Aug. 11, 2021, which claims priority to Chinese patent application No. 202110592281.4 filed May 28, 2021. The contents of these applications are incorporated herein by reference in their entirety.

### TECHNICAL FIELD

The present disclosure relates to the technical field of transient current analysis, and in particular, to a method and a system for analyzing a transient current of a non-polar liquid, an apparatus, and a storage medium.

### BACKGROUND

Surfactants in the non-polar liquids are often added into products such as engine oils, inks, powders, and developers as lubricants, dispersants, and charge control agents, and are widely used in the fields of oil mining, ceramic processing and the like. The addition of surfactants in the non-polar liquids can stabilize charges on the surface of colloidal particles or in the core of inverse micelles, and this characteristic makes the non-polar liquids one of the most important materials for preparing an electrophoretic ink of an electronic paper. The mixture of the non-polar liquids and the surfactants can be regarded as a model of a general electrolyte to study colloidal crystals.

In the non-polar liquids with surfactants, the free charges can only exist in the form of inverse micelles. Usually, applying a step voltage to a non-polar liquid containing a surfactant between two parallel electrodes and measuring the transient current can obtain detailed information about the properties and the generation of charged inverse micelle in the non-polar liquid. In most cases, the interpretation of the transient currents in different phrases varies, requiring multiple experiments to thoroughly analyze the relationship between the generation principle of the transient currents and a plurality of parameters of the non-polar liquid. This complexity results in the need for numerous experiments and extensive data analysis, making the analysis of transient currents intricate and inefficient.

### SUMMARY

The present disclosure aims to at least solve one of the technical problems in the conventional technology. Therefore, the present disclosure provides a method for analyzing a transient current of a non-polar liquid, which can investigate different influencing factors on the transient currents of the to-be-detected devices, so that the analysis of the non-polar liquid is simple and efficient.

The present disclosure further provides a system for analyzing a transient current of a non-polar liquid.

The present disclosure further provides an electronic control apparatus.

The present disclosure further provides a computer-readable storage medium.

According to the first aspect, an embodiment of the present disclosure provides a method for analyzing a transient current of a non-polar liquid, comprising:
measuring a transient current of a to-be-detected device to obtain a transient current reference curve, wherein the to-be-detected device contains a non-polar liquid with a surfactant;
determining experimental parameters of a first influencing factor in the to-be-detected device according to the transient current reference curve and preset equations, and measuring experimental parameters of a second influencing factor in the to-be-detected device;
constructing a transient current reference model according to the experimental parameters of the first influencing factor and the second influencing factor and a preset current model;
adjusting parameters of the first influencing factor and/or the second influencing factor in the transient current reference model to obtain a plurality of transient current models; and
calculating corresponding transient current change data according to the plurality of transient current models so as to construct and output a plurality of transient current curves.

The method for analyzing a transient current of a non-polar liquid provided by the embodiment of the present disclosure at least has the following beneficial effects. The influence of parameters of different influencing factors in a to-be-detected device on the transient current is compared by comparing a plurality of transient current curves and the transient current reference curve, so that the analysis operation of the transient current in the non-polar liquid is simple and easy, a user does not need to perform experiments one by one, and the analysis efficiency of the transient current in the non-polar liquid can also be improved.

According to the method for analyzing a transient current of a non-polar liquid of some other embodiments of the present disclosure, the first influencing factor comprises: charged inverse micelle concentration and mobility; and the second influencing factor comprises one or more of the following: dielectric constant, viscosity, device thickness, temperature, electric field strength, and conductive electrode area.

According to the method for analyzing a transient current of a non-polar liquid of some other embodiments of the present disclosure, the transient current model comprises: a first transient current model, a second transient current model, and a third transient current model; and adjusting parameters of the first influencing factor and/or the second influencing factor in the transient current reference model to obtain a plurality of transient current models comprises:
adjusting parameters of the charged inverse micelle concentration in the transient current reference model to obtain a plurality of first transient current models;
and/or, adjusting parameters of the device thickness in the transient current reference model to obtain a plurality of second transient current models;
and/or, adjusting parameters of the electric field strength in the transient current reference model to obtain a plurality of third transient current models.

The method for analyzing a transient current of a non-polar liquid according to some other embodiments of the present disclosure further comprises:
determining a parameter range of the first influencing factor and/or the second influencing factor according to a preset boundary condition, a preset geometry and a preset initial condition; and
adjusting parameters of the first influencing factor and/or the second influencing factor in the transient current reference model according to the parameter range to obtain a plurality of transient current models.

According to the method for analyzing a transient current of a non-polar liquid of some other embodiments of the present disclosure, the parameter range comprises one or more of the following: a charged inverse micelle concentration range, a device thickness range, and an electric field strength range.

According to the method for analyzing a transient current of a non-polar liquid of some other embodiments of the present disclosure, the calculating corresponding transient current change data according to the plurality of transient current models so as to construct and output a plurality of transient current curves comprises:
determining corresponding grid density according to a boundary distribution of the transient current model;
dividing the transient current model in a grid form according to the grid density to obtain a plurality of grid cells;
calculating and summing transient current change data of the plurality of grid cells to obtain the transient current change data of the transient current model; and
constructing a plurality of transient current curves according to the transient current change data corresponding to the plurality of transient current models.

The method for analyzing a transient current of a non-polar liquid according to some other embodiments of the present disclosure further comprises:
plotting the plurality of transient current curves on the same coordinate axis to obtain a transient current change comparison diagram, and outputting the transient current change comparison diagram.

According to the second aspect, an embodiment of the present disclosure provides a system for analyzing a transient current of a non-polar liquid, comprising:
a first measurement module, configured to measure a transient current of a to-be-detected device to obtain a transient current reference curve, wherein the to-be-detected device contains a non-polar liquid with a surfactant;
a first calculation module, configured to determine experimental parameters of a first influencing factor in the to-be-detected device according to the transient current reference curve and preset equations;
a second measurement module, configured to measure experimental parameters of a second influencing factor in the to-be-detected device;
a construction module, configured to construct a transient current reference model according to the experimental parameters of the first influencing factor and the second influencing factor and a preset current model;
an adjustment module, configured to adjust parameters of the first influencing factor and/or the second influencing factor in the transient current reference model to obtain a plurality of transient current models; and
a second calculation module, configured to calculate corresponding transient current change data according to the plurality of transient current models so as to construct a plurality of transient current curves.

The system for analyzing the transient current of the non-polar liquid provided by the embodiment of the present disclosure at least has the following beneficial effects. The influence of parameters of different influencing factors in a to-be-detected device on the transient current is compared by comparing a plurality of transient current curves and the transient current reference curve, so that the analysis operation of the transient current in the non-polar liquid is simple and easy, a user does not need to perform experiments one by one, and the analysis efficiency of the transient current in the non-polar liquid can also be improved.

According to a third aspect, an embodiment of the present disclosure provides an electronic control apparatus, comprising:
at least one processor; and
a memory communicatively connected to the at least one processor; wherein,
the memory stores instructions executable by the at least one processor, and the instructions, when executed by the at least one processor, cause the at least one processor to perform the method for analyzing a transient current of a non-polar liquid according to the first aspect.

According to a fourth aspect, an embodiment of the present disclosure provides a computer-readable storage medium, wherein the computer-readable storage medium stores computer-executable instructions, and the computer-executable instructions are used to cause a computer to perform the method for analyzing a transient current of a non-polar liquid according to the first aspect.

Other features and advantages of the present application will be claimed later, and will be partly apparent from the specification or may be understood by implementing the present disclosure. The objectives and other advantages of the present application will be implemented and attained by the structure particularly pointed out in the specification and drawings.

### BRIEF DESCRIPTION OF DRAWINGS

FIG. 1 is a schematic flow chart of a method for analyzing a transient current of a non-polar liquid according to an embodiment of the present disclosure;

FIG. 2 is an experimental schematic diagram of a to-be-detected device;

FIG. 3 is a schematic flow chart of a method for analyzing a transient current of a non-polar liquid according to another embodiment of the present disclosure;

FIG. 4 is a schematic diagram of a plurality of first transient current curves;

FIG. 5 is a schematic diagram of a plurality of second transient current curves;

FIG. 6 is a schematic diagram of a plurality of third transient current curves;

FIG. 7 is a schematic flow chart of a method for analyzing a transient current of a non-polar liquid according to another embodiment of the present disclosure;

FIG. 8 is a schematic flow chart of a method for analyzing a transient current of a non-polar liquid according to another embodiment of the present disclosure;

FIG. 9 is a schematic flow chart of a method for analyzing a transient current of a non-polar liquid according to another embodiment of the present disclosure;

FIG. 10 is a block diagram of a system for analyzing a transient current of a non-polar liquid according to an embodiment of the present disclosure; and

FIG. 11 is a block diagram of an electronic control apparatus according to an embodiment of the present disclosure.

Reference numerals: 100: first measurement module; 200: first calculation module; 300: second measurement module; 400: construction module; 500: adjustment module; 600: second calculation module; 700: processor; 800: memory.

### DETAILED DESCRIPTION

The concept of the present disclosure and the resulting technical effects will be clearly and completely described below in conjunction with embodiments, so that the objectives, features, and effects of the present disclosure can be fully understood. It is clear that the described embodiments are merely some rather than all of embodiments of the present disclosure. All other embodiments obtained by those of ordinary skills in the art based on embodiments of the present disclosure without creative efforts shall fall within the protection scope of the present disclosure.

In the description of the present disclosure, if there are directional descriptions, for example, directions or positional relationships indicated by terms such as “upper”, “lower”, “front”, “rear”, “left”, “right” and the like are those shown based on the accompanying drawings, and are merely intended to facilitate and simplify the description of the present disclosure rather than indicate or imply that the indicated apparatus or element must have a specific direction and must be configured and operated according to the specific direction. Therefore, these directions or positional relationships should not be construed as limiting the present disclosure.

In the description of the embodiments of the present application, “several” means one or more, “a plurality of” means two or more, “greater than”, “less than”, “more than” and the like should be understood as excluding the following number, and “above”, “below”, “within” and the like should be understood as including the following number. The description of “first” and “second” is merely for the purpose of distinguishing technical features, but shall not be understood as an indication or implication of relative importance, or an implicit indication of a quantity of indicated technical features, or an implicit indication of the sequence of the indicated technical features.

The surfactants in the non-polar liquids are often added into products such as engine oils, inks, powders, and developers as lubricants, dispersants, and charge control agents, and are widely used in the fields of oil mining, ceramic processing and the like. The addition of surfactants in the non-polar liquids can stabilize charges on the surface of colloidal particles or in the core of inverse micelles, and this characteristic makes the non-polar liquids one of the most important materials for preparing an electrophoretic ink of an electronic paper. The mixture of the non-polar liquids and the surfactants can be regarded as a model of a general electrolyte to study colloidal crystals. The conductivity of the non-polar liquid can be controlled by changing the concentration of the surfactant, which is also of great importance for fundamental research. Nevertheless, the physical mechanism of the origin of the charges in the non-polar liquids containing surfactants is not fully understood at present.

In the non-polar liquids with surfactants, the free charges can only exist in the form of inverse micelles. Usually, applying a step voltage to a non-polar liquid containing a surfactant between two parallel electrodes and measuring the transient current can obtain detailed information about the properties and the generation of charged inverse micelle in the non-polar liquid. In most cases, the interpretation of the transient currents in different phrases varies. This is because the charge concentration in the non-polar liquids is small and it may be completely depleted when a sufficiently high voltage is applied.

Transient currents in the non-polar liquids containing surfactants usually consist of two phases. In the first phase, the current is a result of the movement of the initially existing charge inverse micelles, and it decreases rapidly when the distribution of charges reaches a new equilibrium. This phase can be described by the electrophoretic drift and diffusion of charged inverse micelles, as well as the screening effect on the electric field. In the second stage, after the charges reach quasi-equilibrium, the current decreases very little for a limited time. In the related technology, to analyze which influencing factors dominate the transient currents in the non-polar liquids, a great amount of experiments are required to be performed, so that the analysis of the influencing factors of the transient current of the non-polar liquid is more complicated, and the analysis efficiency is reduced.

Based on this, the present application discloses a method and a system for analyzing a transient current of a non-polar liquid, an apparatus, and a storage medium, the transient current condition of the non-polar liquid under the parameters of different influencing factors is automatically analyzed by constructing a transient current model, so that the principle of current generation in the non-polar liquid containing the surfactant is analyzed.

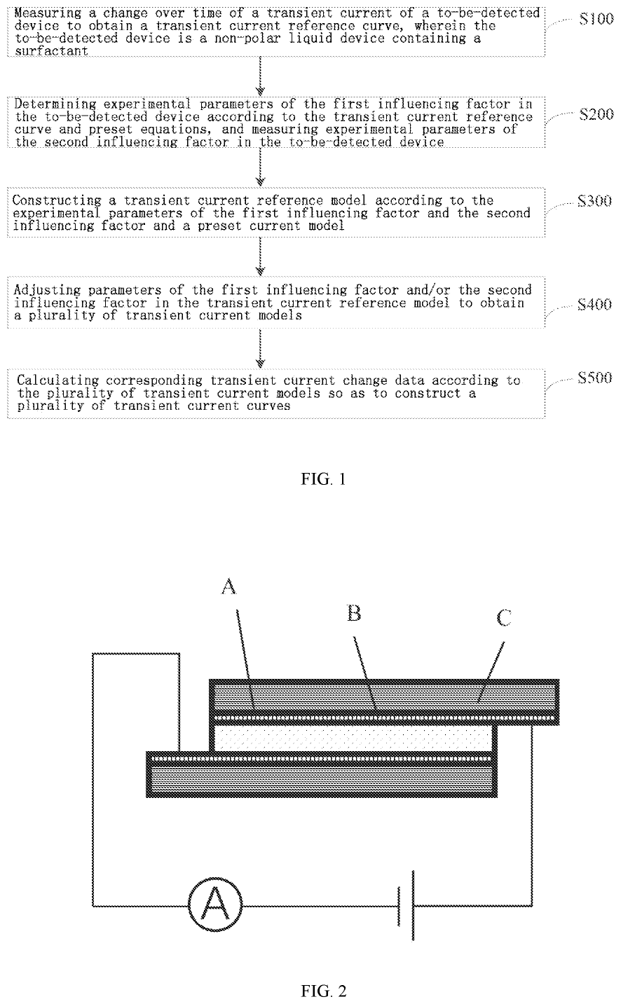

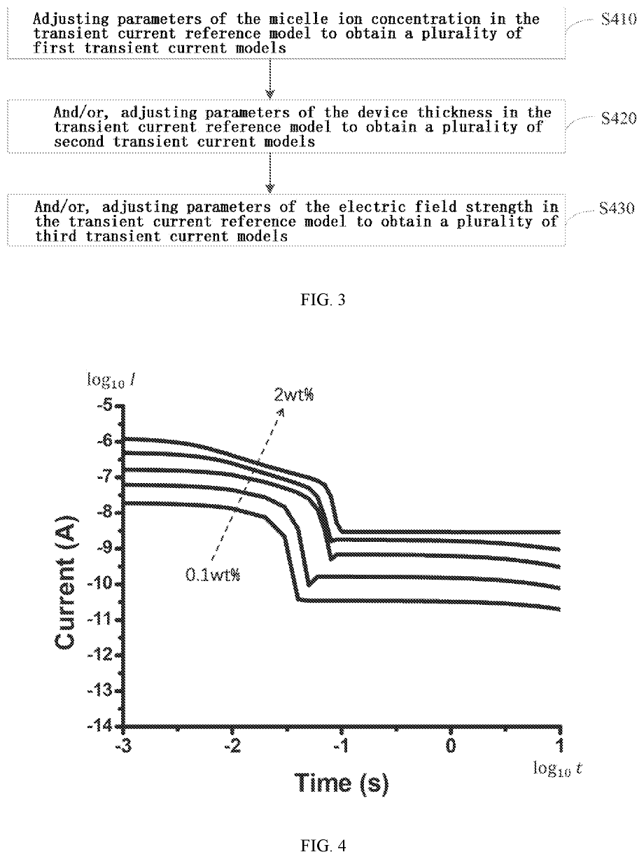

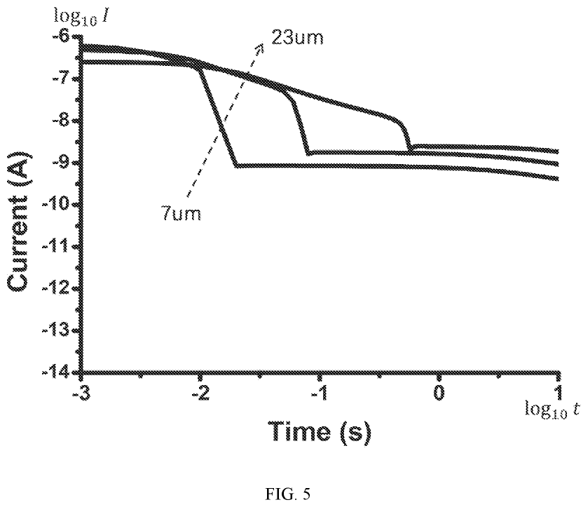

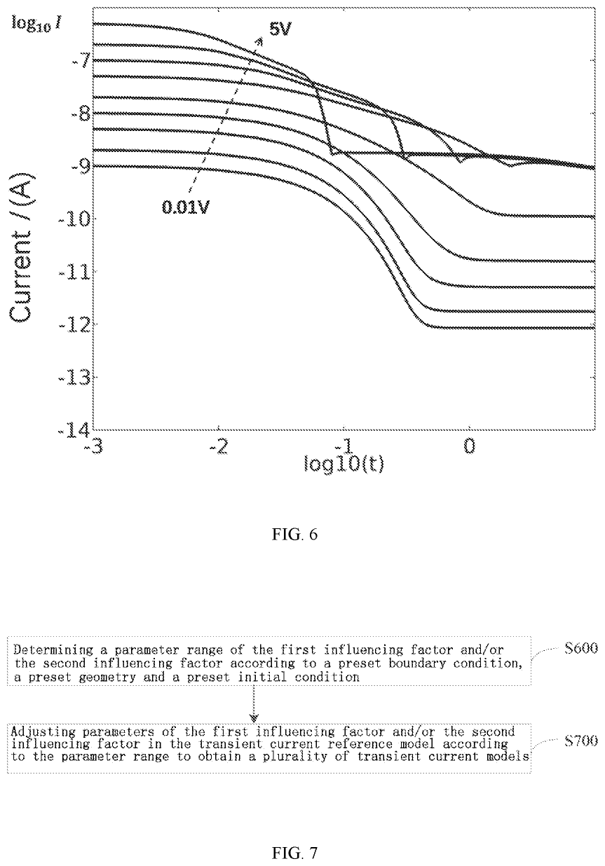

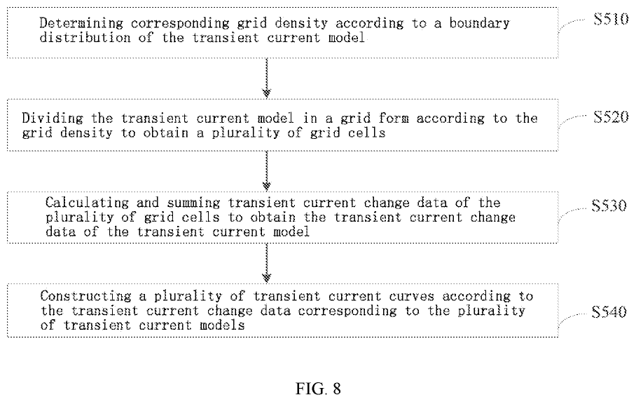

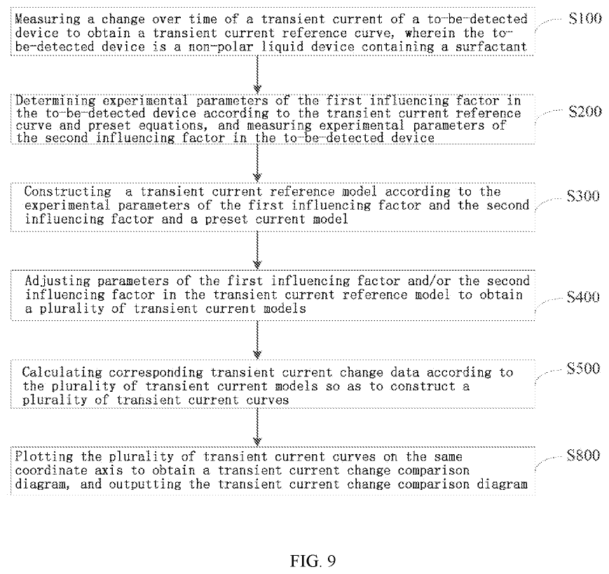

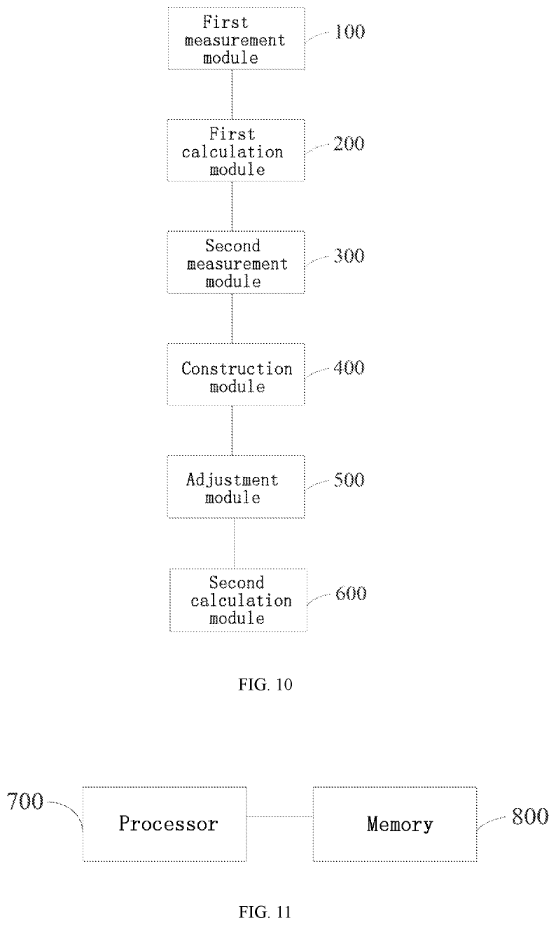

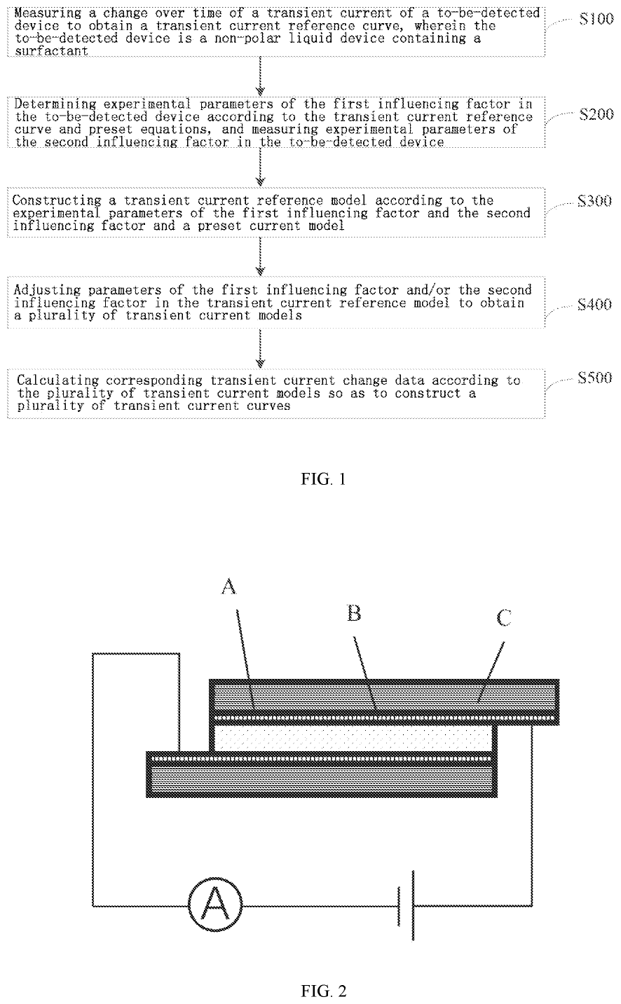

According to the first aspect, referring to FIG. 1, an embodiment of the present disclosure provides a method for analyzing a transient current of a non-polar liquid, comprising:
S100: measuring a transient current of a to-be-detected device to obtain a transient current reference curve, wherein the to-be-detected device contains a non-polar liquid with a surfactant;
S200: determining experimental parameters of the first influencing factor in the to-be-detected device according to the transient current reference curve and preset equations, and measuring experimental parameters of the second influencing factor in the to-be-detected device;
S300: constructing a transient current reference model according to the experimental parameters of the first influencing factor and the second influencing factor and a preset current model;
S400: adjusting parameters of the first influencing factor and/or the second influencing factor in the transient current reference model to obtain a plurality of transient current models; and
S500: calculating corresponding transient current change data according to the plurality of transient current models so as to construct a plurality of transient current curves.

The to-be-detected device is subjected to experimental testing to measure a plurality of transient currents of the to-be-detected device, and the plurality of transient currents are transient currents of the to-be-detected device that change over time, so that a transient current reference curve is constructed through the plurality of transient currents. Experimental parameters of a first influencing factor in the to-be-detected device are determined according to the transient current reference curve and preset equations, and experimental parameters of a second influencing factor in the to-be-detected device are measured. Therefore, experimental parameters of the first influencing factor and the second influencing factor are obtained, and the experimental parameters of the first influencing factor and the second influencing factor are substituted into the preset current model to construct a transient current reference model. A corresponding transient current reference model is constructed through experimental parameters, and then a plurality of transient current models are obtained by adjusting the experimental parameters in the transient current reference model, so as to calculate corresponding transient current change data according to the plurality of transient current models, and construct and output corresponding transient current curves according to the plurality of transient current change data. In this way, the influence of parameters on the transient current can be detected by comparing a plurality of transient current curves and the transient current reference curve, so that the analysis of the transient current in the non-polar liquid is simple and easy, the user does not need to perform experiments one by one, and the analysis efficiency of the transient current in the non-polar liquid can also be improved.

Referring to FIG. 2, FIG. 2 is a schematic diagram of a structure of a to-be-detected device, where A is a non-polar liquid containing a surfactant, B is an ITO electrode, and C is a glass substrate. The to-be-detected device is a non-polar liquid device containing a surfactant, and the surfactant may be, but is not limited to, materials such as OLOA1200, OLOA11000 and AOT; and the non-polar liquid may be, but is not limited to, n-dodecane, n-decane, and n-hexadecane. The to-be-detected device is a device with parallel aligned plates, and the inner surface of the device contains electrodes. The preset current model is a one-dimensional geometric construction model, and the geometric dimensions of the one-dimensional geometric construction model may be, but are not limited to, 7 μm, 12 μm, and 23 μm. The experimental parameters of the first influencing factor and the second influencing factor are obtained through calculations and implemented in one-dimensional geometric construction model. In the one-dimensional geometric construction model corresponds to the to-be-detected device, electrodes are set at two ends of the one-dimensional geometric construction model, and the region between two electrode contains the non-polar fluid with charged inverse micelles. Through setting the one-dimensional geometric construction model that corresponds to the to-be-detected device, different transient current models can be obtained by adjusting the parameters of the first influencing factor and the second influencing factor in the one-dimensional geometric construction model, and the changes in transient current under different parameters are determined by the transient current model, so that automated analysis of transient current in the non-polar liquids is achieved and the labor is saved.

In some embodiments, the first influencing factor comprises: charged inverse micelle concentration and mobility; and the second influencing factor comprises one or more of the following: dielectric constant, viscosity, device thickness, temperature, electric field strength, and conductive electrode area. Since the factors influencing the transient current of the non-polar liquid mainly comprise charged inverse micelle concentration, mobility, dielectric constant, viscosity, device thickness, temperature, electric field strength and conductive electrode area, the influence of different influencing factors on the transient current of the non-polar liquid is determined by determining the parameters of the first influencing factor and the second influencing factor.

The experimental parameters of the first influencing factor need to be determined through a transient current reference curve and preset equations, and the experimental parameters of the second influencing factor can be obtained by directly measuring the to-be-detected device. The experimental parameters of charged inverse micelles concentration and mobility need to be calculated according to a transient current reference curve and preset equations. The experimental parameters of dielectric constant, viscosity, device thickness, temperature, electric field strength and conductive electrode area can be obtained by measuring the to-be-detected device.

In this embodiment, experimental parameters of charged inverse micelle concentration and mobility are determined according to a transient current reference curve and preset equations. There are two preset equations to calculate the concentration and mobility, and the two preset equations are respectively defined as a first preset equation and a second preset equation. The charged inverse micelle concentration is calculated via the following first preset equation:

$$\overline{n} = {n}_{+} = {n}_{-} = \frac{( {\int }_{0}^{{i}_{tr}} ( I - {I}_{g} ) dt )}{eds} \qquad ( 1 )$$

In this equation, n̅ is the experimental parameter of charged inverse micelles concentration, I is the transient current, I_{g} is the ending transient current, e is element charge, d is the thickness of the to-be-detected device, and s is the area of the to-be-detected device.

Once the charged inverse micelle concentration is obtained, the mobility is obtained by substituting the charged inverse micelle concentration and the transient current reference curve into the following second preset equation.

$$μ = \frac{{I}_{( t = 0 s )} d}{2 e \overline{n} {SV}_{0}} \qquad ( 2 )$$

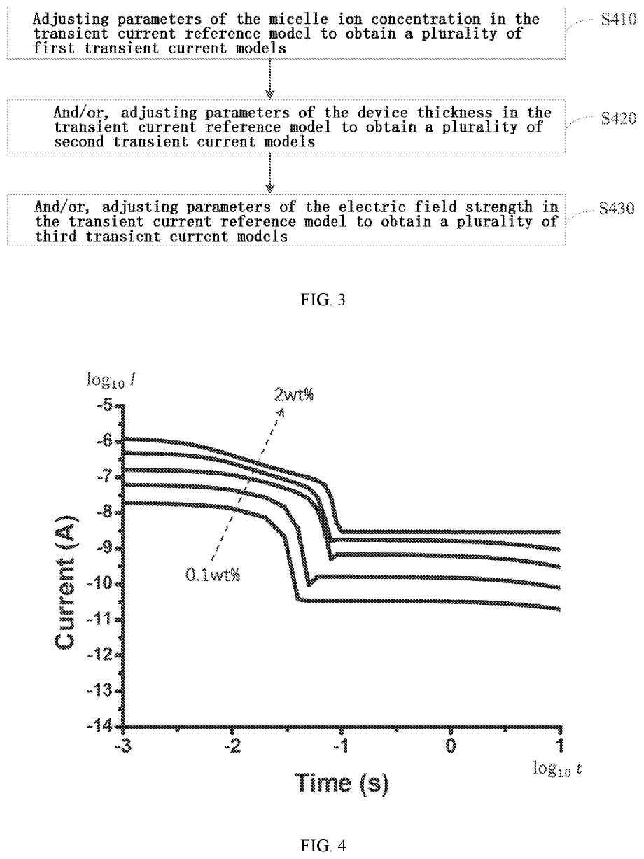

Referring to FIG. 3, in some embodiments, the transient current model comprises: a first transient current model, a second transient current model, and a third transient current model. The step S400 comprises:
S410: adjusting parameters of the charged inverse micelle concentration in the transient current reference model to obtain a plurality of first transient current models;
S420; and/or, adjusting parameters of the device thickness in the transient current reference model to obtain a plurality of second transient current models;
S430; and/or, adjusting parameters of the electric field strength in the transient current reference model to obtain a plurality of third transient current models.

Since the influence of parameters of charged inverse micelle concentration in the non-polar liquid, device thickness and electric field strength on the transient current is large, a plurality of first transient current models are obtained by adjusting the parameters of the charged inverse micelle concentration in the transient current reference model. A plurality of first transient current models are used to determine the degree of influence of adjusting the parameters of the charged inverse micelle concentration on the transient current in a case that other influencing factors remain unchanged. The parameters of the device thickness in the transient current reference model are determined to obtain a plurality of second transient current models, and the influence degree of the device thickness on the transient current of the to-be-detected device is analyzed by the plurality of second transient current models. The parameters of the electric field strength in the transient current reference model are determined to obtain a plurality of third transient current models, so as to clear the influence of different electric field strengths on the transient current of the to-be-detected device by the plurality of third transient current models.

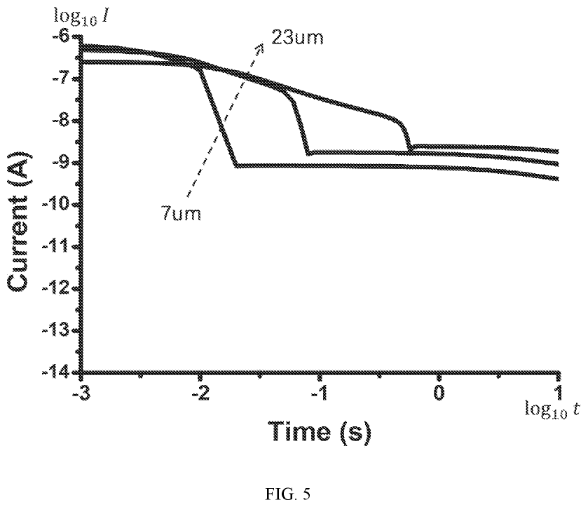

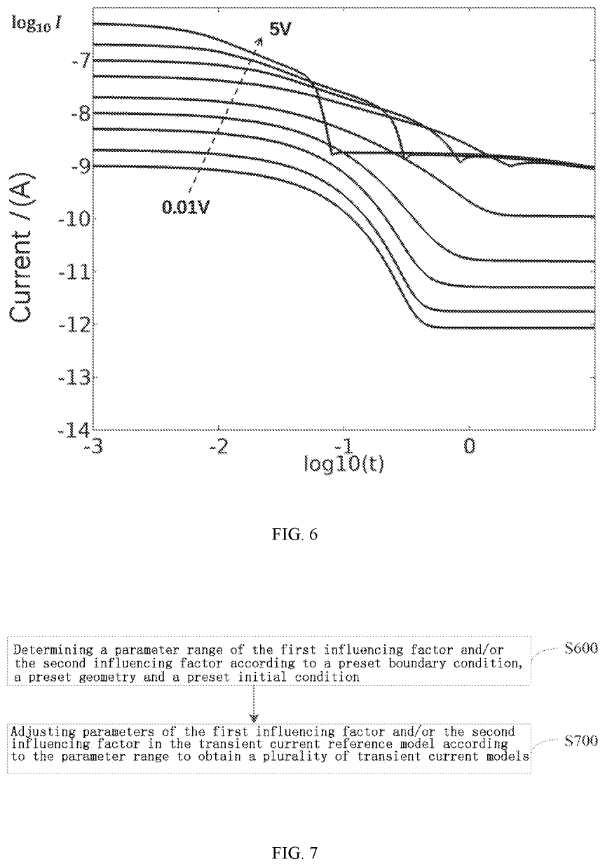

Referring to FIGS. 4, 5 and 6, FIG. 4 shows a plurality of first transient current curves, FIG. 5 shows a plurality of second transient current curves, and FIG. 6 shows a plurality of third transient current curves. The transient current change data comprises: first transient current change data, second transient current change data, and third transient current change data; and the transient current curve comprises: a first transient current curve, a second transient current curve, and a third transient current curve. A plurality of first transient current models, a plurality of second transient current models and a plurality of third transient current models are obtained by adjusting the charged inverse micelle concentration, device thickness and electric field strength in the transient current reference model, a plurality of pieces of first transient current change data can be calculated according to the plurality of first transient current models, and the plurality of pieces of first transient current change data are mainly obtained by changing only the charged inverse micelle concentration of the to-be-detected device. Therefore, a first transient current curve can be obtained according to the first transient current change data, and the first transient current curve is determined by simulating the transient current change data of the to-be-detected device after the charged inverse micelle concentration is changed. Therefore, the influence degree of the charged inverse micelle concentration on the transient current of the to-be-detected device can be determined through the plurality of first transient current curves, and the influence of different charged inverse micelle concentrations on the transient current of the to-be-detected device is further analyzed. A plurality of pieces of second transient current change data are calculated by a plurality of second transient current models, and a plurality of second transient current curves are determined according to the plurality of pieces of second transient current change data, wherein the plurality of second transient current curves simulate the changes of the transient current of the to-be-detected device after only the device thickness of the to-be-detected device is changed, so that the influence of different device thicknesses on the transient current of the to-be-detected device is analyzed through the plurality of second transient current curves. A plurality of pieces of third transient current change data are calculated by a plurality of third transient current models, and a plurality of third transient current curves are determined according to the plurality of pieces of third transient current change data, wherein the plurality of third transient current curves simulate transient current of the to-be-detected device after only the electric field strength of the to-be-detected device is changed. The influence degree of different electric field strengths on the transient current of the to-be-detected device can be analyzed through the plurality of third transient current curves. Therefore, the influence of different charged inverse micelle concentrations, different device thicknesses and different applied electric field strengths on the transient current of the to-be-detected device can be analyzed through the plurality of first transient current curves, the plurality of second transient current curves and the plurality of third transient current curves, and the entire analysis process does not require experiments one by one, so that the analysis operation is simpler and more convenient, and the efficiency is improved.

Referring to FIG. 7, in some embodiments, the method for analyzing a transient current of a non-polar liquid further comprises:
S600: determining a parameter range of the first influencing factor and/or the second influencing factor according to a preset boundary condition, a preset geometry and a preset initial condition; and
S700: adjusting parameters of the first influencing factor and/or the second influencing factor in the transient current reference model according to the parameter range to obtain a plurality of transient current models.

Since the preset current model obtains the transient current reference model according to the experimental parameters of the first influencing factor and the second influencing factor, then, the parameters of the first influencing factor and the second influencing factor in the transient current reference model are adjusted to obtain a plurality of transient current models. However, the parameters of the first influencing factor and the second influencing factor in the transient current reference model cannot be arbitrarily adjusted. Therefore, the parameter range of the first influencing factor and/or the second influencing factor is determined through a preset boundary condition, a preset geometry and a preset initial condition, the parameters of the first influencing factor and/or the second influencing factor in the transient current reference model are adjusted according to the parameter range to obtain a plurality of transient current models, so that the obtained plurality of transient current models meet the requirements.

The parameter range of the first influencing factor and/or the second influencing factor is not only related to the boundary condition, but also related to the initial condition and the geometry of the to-be-detected device, so that the parameter range of the first influencing factor and/or the second influencing factor is determined according to the preset boundary condition, the preset geometry and the preset initial condition, and the transient current model obtained by adjusting the transient current reference model according to the parameter range better satisfies the changes of the transient current of the to-be-detected device. The parameter range comprises one or more of the following: a charged inverse micelle concentration range, a device thickness range, and an electric field strength range.

The parameter range of the transient concentration and/or the device thickness and/or the electric field strength in the transient current reference model is determined according to the charged inverse micelle concentration range and/or the device thickness range and/or the electric field strength range, and then the parameters of influencing factors in the transient current reference model are adjusted according to the charged inverse micelle concentration range and/or the device thickness range and/or the electric field strength range to obtain a plurality of first transient current models and/or a plurality of second transient current models and/or a plurality of third transient current models. Therefore, the concentration range and/or the device thickness range and/or the electric field strength range are determined, and then the parameters of the first influencing factor and the second influencing factor in the transient current reference model are adjusted, so that the obtained transient current models meet the requirements.

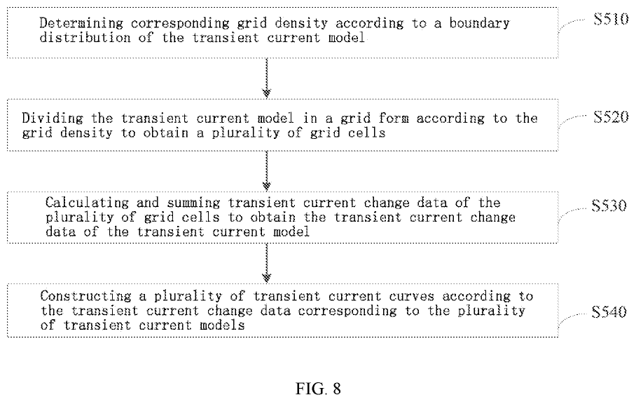

Referring to FIG. 8, in some embodiments, the step S500 comprises:
S510: determining corresponding grid density according to a boundary distribution of the transient current model;
S520: dividing the transient current model in a grid form according to the grid density to obtain a plurality of grid cells;
S530: calculating and summing transient current change data of the plurality of grid cells to obtain the transient current change data of the transient current model; and
S540: constructing a plurality of transient current curves according to the transient current change data corresponding to the plurality of transient current models.

Since directly calculating the transient current change data according to the transient current model is complicate and less accurate. the grid density is determined according to the boundary distribution of the transient current model, then the transient current model is meshed according to the grid density to obtain a plurality of grid cells, and the numerical value of each grid cell is calculated and summed to obtain the transient current change data, so that the transient current change data obtained by calculation is more accurate and the calculation is simple and easy. The grid density close to the one-dimensional geometric boundary in the transient current model is large, and the maximum grid size is 5 nm. The transient current model is divided in a grid form to obtain a plurality of grid cells, and then the numerical values of the plurality of grid cells are calculated to obtain transient current change data, so that the calculation of the transient current change data is easy and accurate, and therefore the transient current curve is easy to determine according to the transient current change data, and the influence degree of different charged inverse micelle concentrations, different device thicknesses and different applied electric field strengths on the transient current of the to-be-detected device is accurately analyzed.

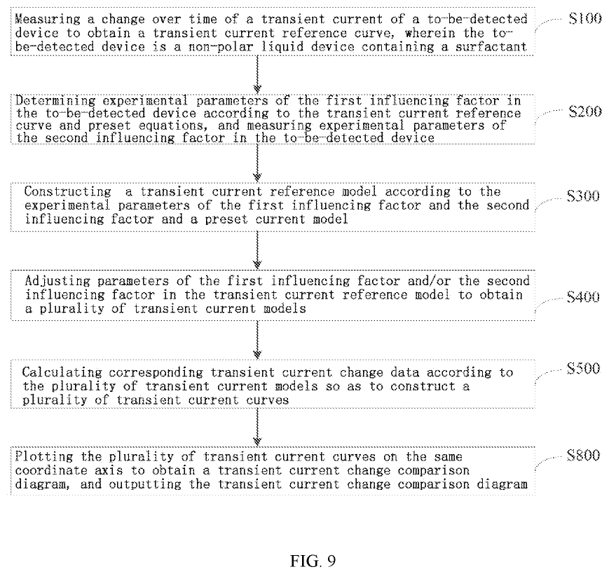

Referring to FIG. 9, in some embodiments, the method for analyzing a transient current of a non-polar liquid further comprises:

S800: plotting the plurality of transient current curves on the same coordinate axis to obtain a transient current change comparison diagram, and outputting the transient current change comparison diagram. A plurality of transient current curves are plotted on the same coordinate axis to obtain a transient current change comparison diagram, so that a user can analyze the influence of different influencing factors on the transient current of the to-be-detected device through the transient current change comparison diagram.

The comparison of the transient current change comprises: a first transient current change comparison diagram, a second transient current change comparison diagram and a third transient current change comparison diagram; therefore, the plurality of first transient current curves are plotted on the same coordinate axis to obtain a first transient current change comparison diagram, and then the influence of different charged inverse micelle concentrations on the transient current of the to-be-detected device can be analyzed through the first transient current change comparison diagram. A plurality of second transient current curves are plotted on the same coordinate axis to obtain a second transient current change comparison diagram, so that the influence of different device thicknesses on the transient current of the to-be-detected device can be analyzed according to the second transient current change comparison diagram. A plurality of third transient current curves are plotted on the same coordinate axis to obtain a third transient current change comparison diagram, so that the influence of different electric field strengths on the transient current of the to-be-detected device can be analyzed through the third transient current change comparison diagram. The influence of different charged inverse micelle concentrations, different device thicknesses and different applied electric field strengths on the transient current of the non-polar liquid can be analyzed through the first transient current change comparison diagram, the second transient current change comparison diagram and the third transient current change comparison diagram.

The method for analyzing a transient current of a non-polar liquid according to an embodiment of the present disclosure is described in detail in one specific embodiment with reference to FIGS. 1 to 9. It should be understood that the following description is illustrative only and is not intended as a specific limitation to the present disclosure.

The to-be-detected device is subjected to experimental testing to measure a plurality of transient currents of the to-be-detected device, and the plurality of transient currents are transient currents of the to-be-detected device that change over time, so that a transient current reference curve is constructed through the plurality of transient currents, charged inverse micelle concentration is obtained through calculation according to the transient current reference curve and a first preset equation, and mobility is obtained through calculation according to the charged inverse micelle concentration, the transient current reference curve and a second preset equation. Therefore, experimental parameters of charged inverse micelle concentration and mobility are obtained, experimental parameters of the dielectric constant, viscosity, device thickness, temperature, electric field strength and conductive electrode area are measured, and the experimental parameters of the ion concentration, mobility, dielectric constant, viscosity, device thickness, temperature, electric field strength and conductive electrode area are substituted into a preset current model to obtain a transient current reference model. The parameter range of the transient concentration and/or the device thickness and/or the electric field strength in the transient current reference model is determined according to the charged inverse micelle concentration range and/or the device thickness range and/or the electric field strength range, and then the parameters of the transient current reference model are adjusted according to the charged inverse micelle concentration range and/or the device thickness range and/or the electric field strength range to obtain a plurality of first transient current models and/or a plurality of second transient current models and/or a plurality of third transient current models. The grid density is determined according to the boundary distribution of the transient current model, then the transient current model is divided according to the grid density to obtain a plurality of grid cells, and the numerical value of each grid cell is calculated and summed to obtain the transient current change data, so that the transient current change data obtained by calculation is more accurate and the calculation is simple and easy. The plurality of first transient current curves are plotted on the same coordinate axis to obtain a first transient current change comparison diagram, the plurality of second transient current curves are plotted on the same coordinate axis to obtain a second transient current change comparison diagram, and the plurality of third transient current curves are drawn on the same coordinate axis to obtain a third transient current change comparison diagram. The influence of different charged inverse micelle concentrations, different device thicknesses and different applied electric field strengths on the transient current of the non-polar liquid can be analyzed through the first transient current change comparison diagram, the second transient current change comparison diagram and the third transient current change comparison diagram. Therefore, the present application establishes the transient current reference model through the preset current model and the experimental parameters of the influencing factors so as to perform simulation calculation on the performance of the non-polar liquid device containing the surfactant, obtains a quantitative relationship between the transient current and the time by adjusting the experimental parameters of the first influencing factor and the second influencing factor, achieves theoretically explaining the experimental phenomenon, greatly saves the cost and the time, and thus has important practical significance for researching the application of the non-polar liquid containing the surfactant.

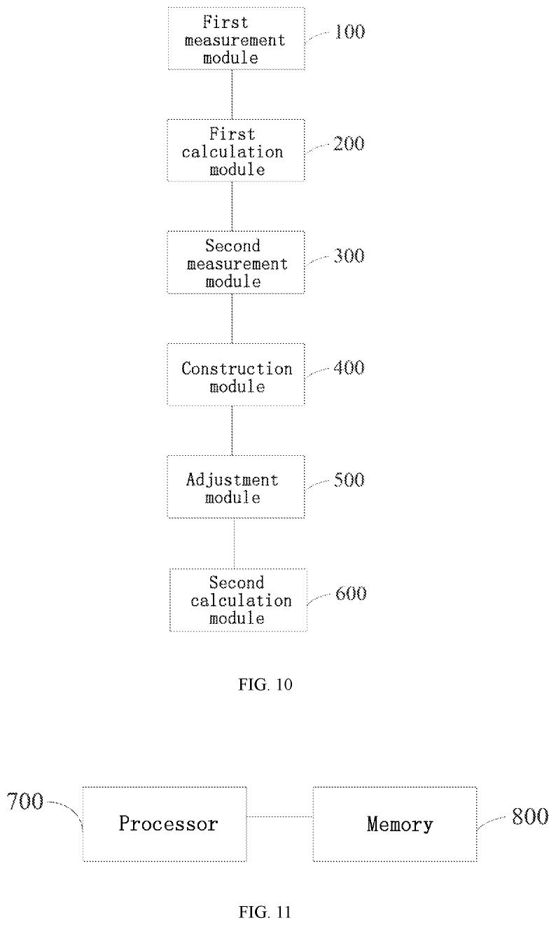

Referring to FIG. 10, according to a second aspect, an embodiment of the present disclosure further discloses a system for analyzing a transient current of a non-polar liquid, comprising: a first measurement module 100, a first calculation module 200, a second measurement module 300, a construction model, an adjustment module 500, and a second calculation module 600; wherein the first measurement module 100 is configured to measure a transient current of a to-be-detected device to obtain a transient current reference curve, wherein the to-be-detected device contains a non-polar liquid with a surfactant; the first calculation module 200 is configured to determine experimental parameters of a first influencing factor in the to-be-detected device according to the transient current reference curve and preset equations; the second measurement module 300 is configured to measure experimental parameters of a second influencing factor in the to-be-detected device; the construction module 400 is configured to construct a transient current reference model according to the experimental parameters of the first influencing factor and the second influencing factor and a preset current model; the adjustment module 500 is configured to adjust parameters of the first influencing factor and/or the second influencing factor in the transient current reference model to obtain a plurality of transient current models; and the second calculation module 600 is configured to calculate corresponding transient current change data according to the plurality of transient current models so as to construct a plurality of transient current curves.

The first measurement module 100 measures a transient current of a to-be-detected device to obtain a transient current reference curve, the first calculation module 200 determines experimental parameters of a first influencing factor in the to-be-detected device according to the transient current reference curve and preset equations, the second measurement module 300 measures experimental data of a second influencing factor in the to-be-detected device, then the construction module 400 determines a transient current reference model according to the preset current model and the experimental parameters of the first influencing factor and the second influencing factor, the adjustment module 500 adjusts the experimental parameters of the first influencing factor and/or the second influencing factor in the transient current reference model to obtain a plurality of transient current models, and therefore, the second calculation module 600 obtain a plurality of transient current change data by calculation according to the plurality of transient current models to obtain a plurality of transient current curves. The influence of different charged inverse micelle concentrations, different device thicknesses and different applied electric field strengths on the transient current of the to-be-detected device is analyzed through the plurality of transient current curves. Therefore, the present disclosure greatly saves cost and time, and plays an important role in researching the application of the non-polar liquid containing the surfactant.

According to a third aspect, referring to FIG. 11, an embodiment of the present disclosure further discloses an electronic control apparatus, comprising: at least one processor 700, and a memory 800 communicatively connected to the at least one processor 700; wherein the memory 800 stores instructions executable by the at least one processor 700, and when the instructions are executed by the at least one processor 700, the at least one processor 700 can perform the method for analyzing a transient current of a non-polar liquid according to the first aspect.

According to a fourth aspect, an embodiment of the present disclosure further discloses a computer-readable storage medium, wherein the computer-readable storage medium stores computer-executable instructions, and the computer-executable instructions are used to cause a computer to perform the method for analyzing a transient current of a non-polar liquid according to the first aspect.

The apparatus embodiments described above are merely an example. The units described as separate parts may or may not be physically separate, may be located in one position, or may be distributed on a plurality of network units. Some or all the modules may be selected according to an actual need to achieve the objectives of the solutions of the embodiments.

It will be understood by those of ordinary skill in the art that all or some of the steps, systems, and methods disclosed above may be implemented as software, firmware, hardware, or suitable combinations thereof. Some or all of the physical components may be implemented as software executed by a processor, such as a central processing unit, a digital signal processor or a microprocessor, or as hardware, or as an integrated circuit, such as an application specific integrated circuit. Such software may be distributed on the computer-readable medium, and the computer-readable medium may include a computer storage medium (or a non-transitory medium) and a communication medium (or a transitory medium). It is well known to those of ordinary skill in the art that the term “computer storage medium” includes volatile and nonvolatile, removable and non-removable medium implemented in any method or technology for storage of information such as computer-readable instructions, data structures, program modules or other data. The computer storage medium includes, but is not limited to, RAM, ROM, EEPROM, a flash memory or other memory technologies, CD-ROM, a digital video disc (DVD) or other optical disk storage, a magnetic cassette, a magnetic tape, magnetic disk storage or other magnetic storage apparatuses, or any other medium that can be used to store the desired information and can be accessed by a computer. In addition, it is well known to those of ordinary skill in the art that communication medium typically embodies computer-readable instructions, data structures, program modules or other data in a modulated data signal such as a carrier wave or other transport mechanism and may include any information delivery medium.

The embodiments of the present disclosure have been described in detail with reference to the accompanying drawings, however, the present disclosure is not limited to the foregoing embodiments. Various changes can be made within the knowledge of those of ordinary skill in the art without departing from the gist of the present disclosure. In addition, the embodiments and features in the embodiments of the present disclosure can be combined with each other without conflict

What is claimed is:

1. A method for analyzing a transient current of a non-polar liquid, comprising:
measuring a transient current of a to-be-detected device to obtain a transient current reference curve, wherein the to-be-detected device contains a non-polar liquid with a surfactant;
determining experimental parameter of a first influencing factor in the to-be-detected device according to the transient current reference curve and preset equations, and measuring experimental parameters of a second influencing factor in the to-be-detected device;
constructing a transient current reference model according to the experimental parameters of the first influencing factor and the second influencing factor and a preset current model;
adjusting parameters of the first influencing factor and/or the second influencing factor in the transient current reference model to obtain a plurality of transient current models; and
calculating corresponding transient current change data according to the plurality of transient current models so as to construct and output a plurality of transient current curves.

2. The method for analyzing a transient current of a non-polar liquid according to claim 1, wherein the first influencing factor comprises: charged inverse micelle concentration and mobility; and the second influencing factor comprises one or more of dielectric constant, viscosity, device thickness, temperature, electric field strength, and conductive electrode area.

3. The method for analyzing a transient current of a non-polar liquid according to claim 2, wherein the transient current model comprises: a first transient current model, a second transient current model, and a third transient current model; and adjusting parameters of the first influencing factor and/or the second influencing factor in the transient current reference model to obtain a plurality of transient current models comprises:
adjusting parameters of the charged inverse micelle concentration in the transient current reference model to obtain a plurality of first transient current models;
and/or, adjusting parameters of the device thickness in the transient current reference model to obtain a plurality of second transient current models;
and/or, adjusting parameters of the electric field strength in the transient current reference model to obtain a plurality of third transient current models.

4. The method for analyzing a transient current of a non-polar liquid according to claim 1, further comprising:
determining a parameter range of the first influencing factor and/or the second influencing factor according to a preset boundary condition, a preset geometry and a preset initial condition; and
adjusting parameters of the first influencing factor and/or the second influencing factor in the transient current reference model according to the parameter range to obtain a plurality of transient current models.

5. The method for analyzing a transient current of a non-polar liquid according to claim 4, wherein the parameter range comprises one or more of the following: a charged inverse micelle concentration range, a device thickness range, and an electric field strength range.

6. The method for analyzing a transient current of a non-polar liquid according to claim 1, wherein the calculating corresponding transient current change data according to the plurality of transient current models so as to construct and output a plurality of transient current curves comprises:
determining corresponding grid density according to a boundary distribution of the transient current model;
dividing the transient current model in a grid form according to the grid density to obtain a plurality of grid cells;
calculating and summing transient current change data of the plurality of grid cells to obtain the transient current change data of the transient current model; and
constructing a plurality of transient current curves according to the transient current change data corresponding to the plurality of transient current models.

7. The method for analyzing a transient current of a non-polar liquid according to claim 6, further comprising:
plotting the plurality of transient current curves on the same coordinate axis to obtain a transient current change comparison diagram, and outputting the transient current change comparison diagram.

8. (canceled)

9. An electronic control apparatus, comprising:
at least one processor; and
a memory communicatively connected to the at least one processor; wherein,
the memory stores instructions executable by the at least one processor, and the instructions, when executed by the at least one processor, cause the at least one processor to perform a method for analyzing a transient current of a non-polar liquid comprising:
measuring a transient current of a to-be-detected device to obtain a transient current reference curve, wherein the to-be-detected device contains a non-polar liquid with a surfactant;
determining experimental parameters of a first influencing factor m the to-be-detected device according to the transient current reference curve and preset equations, and measuring experimental parameters of a second influencing factor in the to-be-detected device;
constructing a transient current reference model according to the experimental parameters of the first influencing factor and the second influencing factor and a preset current model;
adjusting parameters of the first influencing factor and/or the second influencing factor in the transient current reference model to obtain a plurality of transient current models; and
calculating corresponding transient current change data according to the plurality of transient current models so as to construct and output a plurality of transient current curves.

10. A non-transitory computer-readable storage medium, wherein the computer-readable storage medium stores computer-executable instructions, and the computer-executable instructions are used to cause a computer to perform a method for analyzing a transient current of a non-polar liquid comprising:
measuring a transient current of a to-be-detected device to obtain a transient current reference curve, wherein the to-be-detected device contains a non-polar liquid with a surfactant;
determining experimental parameters of a first influencing factor in the to-be-detected device according to the transient current reference curve and preset equations, and measuring experimental parameters of a second influencing factor in the to-be-detected device;
constructing a transient current reference model according to the experimental parameters of the first influencing factor and the second influencing factor and a preset current model;
adjusting parameters of the first influencing factor and/or the second influencing factor in the transient current reference model to obtain a plurality of transient current models; and
calculating corresponding transient current change data according to the plurality of transient current models so as to construct and output a plurality of transient current curves.

11. The electronic control apparatus according to claim 9, wherein the first influencing factor comprises: charged inverse micelle concentration and mobility; and the second influencing factor comprises one or more of dielectric constant, viscosity, device thickness, temperature, electric field strength, and conductive electrode area.

12. The electronic control apparatus according to claim 11, wherein the transient current model comprises: a first transient current model, a second transient current model, and a third transient current model; and adjusting parameters of the first influencing factor and/or the second influencing factor in the transient current reference model to obtain a plurality of transient current models comprises:
adjusting parameters of the charged inverse micelle concentration in the transient current reference model to obtain a plurality of first transient current models;
and/or, adjusting parameters of the device thickness in the transient current reference model to obtain a plurality of second transient current models;
and/or, adjusting parameters of the electric field strength in the transient current reference model to obtain a plurality of third transient current models.

13. The electronic control apparatus according to claim 9, wherein the method for analyzing a transient current of a non-polar liquid further comprises:
determining a parameter range of the first influencing factor and/or the second influencing factor according to a preset boundary condition, a preset geometry and a preset initial condition; and
adjusting parameters of the first influencing factor and/or the second influencing factor in the transient current reference model according to the parameter range to obtain a plurality of transient current models.

14. The electronic control apparatus according to claim 13, wherein the parameter range comprises one or more of the following: a charged inverse micelle concentration range, a device thickness range, and an electric field strength range.

15. The electronic control apparatus according to claim 9, wherein the calculating corresponding transient current change data according to the plurality of transient current models so as to construct and output a plurality of transient current curves comprises:
determining corresponding grid density according to a boundary distribution of the transient current model;
dividing the transient current model in a grid form according to the grid density to obtain a plurality of grid cells;
calculating and summing transient current change data of the plurality of grid cells to obtain the transient current change data of the transient current model; and
constructing a plurality of transient current curves according to the transient current change data corresponding to the plurality of transient current models.

16. The electronic control apparatus according to claim 15, wherein the method for analyzing a transient current of a non-polar liquid further comprises:
plotting the plurality of transient current curves on the same coordinate axis to obtain a transient current change comparison diagram, and outputting the transient current change comparison diagram.

17. The non-transitory computer-readable storage medium according to claim 10, wherein the first influencing factor comprises: charged inverse micelle concentration and mobility; and the second influencing factor comprises one or more of dielectric constant, viscosity, device thickness, temperature, electric field strength, and conductive electrode area.

18. The non-transitory computer-readable storage medium according to claim 17, wherein the transient current model comprises: a first transient current model, a second transient current model, and a third transient current model; and adjusting parameters of the first influencing factor and/or the second influencing factor in the transient current reference model to obtain a plurality of transient current models comprises:
adjusting parameters of the charged inverse micelle concentration in the transient current reference model to obtain a plurality of first transient current models;
and/or, adjusting parameters of the device thickness in the transient current reference model to obtain a plurality of second transient current models;
and/or, adjusting parameters of the electric field strength in the transient current reference model to obtain a plurality of third transient current models.

19. The non-transitory computer-readable storage medium according to claim 10, wherein the method for analyzing a transient current of a non-polar liquid further comprises:
determining a parameter range of the first influencing factor and/or the second influencing factor according to a preset boundary condition, a preset geometry and a preset initial condition; and
adjusting parameters of the first influencing factor and/or the second influencing factor in the transient current reference model according to the parameter range to obtain a plurality of transient current models.

20. The non-transitory computer-readable storage medium according to claim 19, wherein the parameter range comprises one or more of the following: a charged inverse micelle concentration range, a device thickness range, and an electric field strength range.
